(19) United States
(12) Patent Application Publication
(10) Pub. No.: US 2006/0123636 A1
(43) Pub. Date: Jun. 15, 2006

(54) Tool for trimming edges of a board

(76) Inventors: Thomas F. Schulner, Tacoma, WA (US); Arden L. Kunkel, Tacoma, WA (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/009,828

(22) Filed: Dec. 9, 2004

(51) Int. Cl. B26B 7/00

(52) U.S. Cl. 30/276; 30/287

(57) ABSTRACT

A cover, a board assembly and a method for protecting a board are provided. A tool for trimming edges of a board is also provided. The tool has blades disposed on opposite sides of a frame which enable a user to trim edges of a board simultaneously and symmetrically. A top portion of each of the boards is trimmed proximate to lengthwise edges. In an alternate embodiment, the boards are trimmed prior to assembly of the deck to create a groove along each of the edges. A cover, constructed from a wood/plastic composite, is placed on each of the boards. The cover extends across a top surface of each of the boards and into the grooves created by trimming of the board. Accordingly, a deck utilizing-one-or more covers may be used for a prolonged period of time.

### FIELD OF THE INVENTION

This invention relates generally to a tool for trimming edges of a board. More specifically, the tool enables a user to trim edges of a board simultaneously and symmetrically.

### BACKGROUND OF THE INVENTION

A typical deck floor or wall consists of two or more boards placed adjacent to one another lengthwise. Adjacent edges of the boards are placed at a close distance to one another to prevent objects from falling between the boards. Each of the boards has a top surface upon which a user, for example, stands, walks, or the like. The top surface of the deck is susceptible to precipitation as well as other weather conditions. For example, exposure to heat and/or solar radiation can cause the boards to shrink. Exposure to moisture can cause warping of boards. In addition, moisture causes expansion of the boards such that the boards expand into the space between one another. As a result, debris and other contaminants can become caught between the boards. These particles can cause structural deterioration of the deck. Removing these particles can be a labor-intensive task and one which can be damaging to the deck depending on a type of method chosen for removal.

When a deck surface is damaged, a deck owner is forced to repair the deck, or, as a more costly alternative, replace the deck. A factor in the high cost of replacing a deck is the cost of natural woods, such as pine, fir, cedar or the like. Composite or engineered woods are desirable for deck construction due to their strength. However, these types of woods are treated with preservatives which typically wash away, or dissipate, when exposed to precipitation. A need exists, therefore, to protect a surface of a deck floor from damages caused by weather-related effects and/or other conditions. A further need exists to utilize engineered woods to construct a deck wherein preservatives associated with the engineered woods are not at risk of contact with precipitation.

### SUMMARY OF THE INVENTION

The present invention provides a cover, a board assembly and a method for protecting a board wherein a protective cover is placed on a surface of the board to prevent damage to the board from elements, such as, for example, solar radiation or moisture. In an embodiment, a plurality of boards may be utilized in construction of a deck. The boards are arranged adjacent to one another, each having a top surface and a bottom surface. Opposing edges of the boards may be trimmed in an area proximate to the top surface to create grooves along the board. In an alternate embodiment, the opposing edges may be trimmed prior to arranging of the boards in a floor-type formation. In a further embodiment, the cover is placed on the board without trimming of the board prior to placement.

A cover, or sheet, is placed along the top surface of each of the boards. The cover may be constructed from a composite of wood and plastic wherein the cover is approximately 25-75% wood and 25-75% plastic. The cover extends along the top surface. Ends of the cover are positioned adjacent to the grooves in the opposing edges. The protective cover may be secured to the board via an adhesive and/or a fastener, such as a screw. The fasteners may be sized to secure each of the boards to joists. The cover prevents direct contact of the board by elements, such as solar radiation or precipitation. As a result, the top surface of the board may be maintained while the cover provides an aesthetic appearance. Accordingly, the deck may be used for a prolonged period of time.

In an embodiment, a deck is comprised of one or more board assemblies. Each board assembly has a board having a first surface and a second surface opposite the first surface. The board also has edges on opposing sides. The edges define a height between the first surface and the second surface. A width between the edges adjacent to the first surface is not equal to a width between the edges adjacent to the second surface. A cover, or sheet, is provided on the first surface of the board. The sheet has a width substantially similar to a width for the first surface of the board. The sheet extends along at least one of the edges and is constructed from wood and plastic. A space exists between the sheet and the first surface of the board.

The present invention also provides a tool for trimming edges of a board. To this end, in an embodiment, the tool has a frame having a length between a front end and a rear end and a width extending from a first side to a second side. A motor within the frame has a first shaft which extends from the rear end to the front end. A second shaft, which extends from the first side and the second side of the frame, is orthogonal to the first shaft and is in mechanical connection with the first shaft. Rotation of the first shaft causes rotation of the second shaft. A first blade is positioned on the second shaft on the first side of the frame. The second shaft serves as an axis of rotation for the first blade. A position of the first blade is adjustable along a length of the second shaft. A second blade is positioned on the second shaft on the second side of the frame. The second shaft serves as an axis of rotation for the second blade. Similar to the first blade, a position of the second blade is adjustable along a length of the second shaft. A base having one or more wheels is attached to a bottom surface of the frame.

It is, therefore, an advantage of the present invention to provide a cover, a board assembly and a method for protecting a board wherein a cover is placed along a board to prevent direct contact between weather-related elements and a top surface of the board; wherein the cover prevents deterioration of the board; and wherein the board may be used for a prolonged period of time.

It is an additional advantage of the present invention to provide a tool for trimming edges of a board wherein the tool allows simultaneous and symmetrical trimming of edges.

Additional features and advantages of the present invention are described in, and will be apparent from, the detailed description of the present embodiments and from the drawings.

### BRIEF DESCRIPTION OF THE DRAWINGS

The embodiments of the present invention are described in detail below with reference to the following drawings.

FIG. 1 is a cross-sectional view of two boards utilized in a deck;

FIG. 2 is a cross-sectional view of the boards of FIG. 1 which are trimmed in accordance with the present invention;

FIG. 3 is a cross-sectional view of a cover secured to the boards of FIG. 2 in accordance with the present invention;

FIG. 4 is a cross-sectional view of a cover secured to a board in another embodiment of the present invention;

FIG. 5 is a cross-sectional view of a cover secured to a board in another embodiment of the present invention;

FIG. 6 is a cross-sectional view of a cover secured to a board in another embodiment of the present invention;

FIG. 7 is a side view of a tool for trimming edges of a board in an embodiment of the present invention;

FIG. 8 is a top plan view of the tool of FIG. 7;

FIG. 9A is a rear view of the tool of FIG. 7; and

FIG. 9B is a rear view of the tool of FIG. 7 in which blades of the tool are separated at a distance greater than the separation seen in FIG. 9A.

### DETAILED DESCRIPTION OF THE INVENTION

The present invention relates to a cover, a board assembly and a method for protecting a board. More specifically, the present invention provides one or more boards which are adjacent, as in a floor of a deck. In an embodiment, a top portion of the boards is trimmed proximate to lengthwise edges. In an alternate embodiment, the boards are trimmed prior to assembly of the deck. A space is created between each board due to trimming of the edges. A cover having a substantially planar shape is placed on each of the boards. The cover may be constructed from a wood/plastic composite and extends across a width of each of the boards into the space created by trimming of the boards. The cover may be secured to the board via an adhesive and prevents direct contact and deterioration due to weather-related elements. As a result, a deck utilizing one or more covers can be used for a prolonged period of time.

The present invention also relates to a tool for trimming edges of a board. The tool may have a frame which contains a shaft that extends from each side of the frame. Blades are disposed on the shaft on opposing sides of the frame. The blades are rotated simultaneously and enable a user to trim edges of a board symmetrically. A base is attached underneath the frame. The base has guides on opposing sides which contact sides of a board during cutting to keep the tool properly aligned with the board. Wheels are disposed at a front end and a rear end of the tool. The wheels at the front end have a width which is less than a width of the wheels at the rear end to provide stability to the tool during a cutting process.

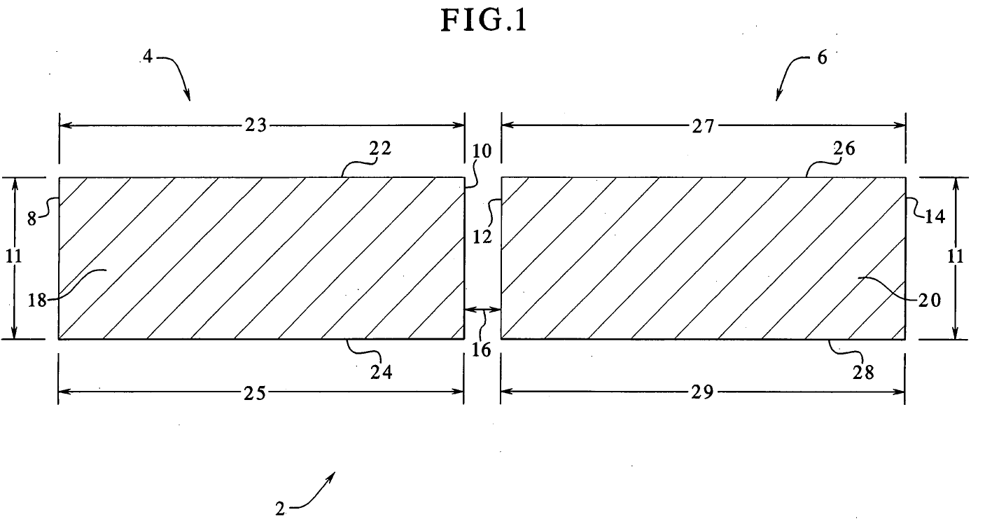

Referring now to the drawings wherein like numerals refer to like parts, FIG. 1 illustrates an isolated portion of a conventional deck 2 which has adjacent boards 4, 6 shown in cross-section. The boards 4, 6 may be constructed from any type of wood suitable for assembly of a deck. In an embodiment, the boards are constructed from engineered strand lumber. The boards 4, 6 may have dimensions, such as, for example, 2 inches by 4 inches, 2 inches by 6 inches, or any other dimension suitable for construction of a deck utilizing a plurality of boards. Board 4 has edges 8, 10 and board 6 has edges 12, 14. In an embodiment, the edges 8, 10, 12, 14 have a height 11 in a range from ½ inch to 6 inches. The edge 10 is adjacent to the edge 12 and is separated by a distance 16 which may be in a range from 1/16 inch to 1 inch.

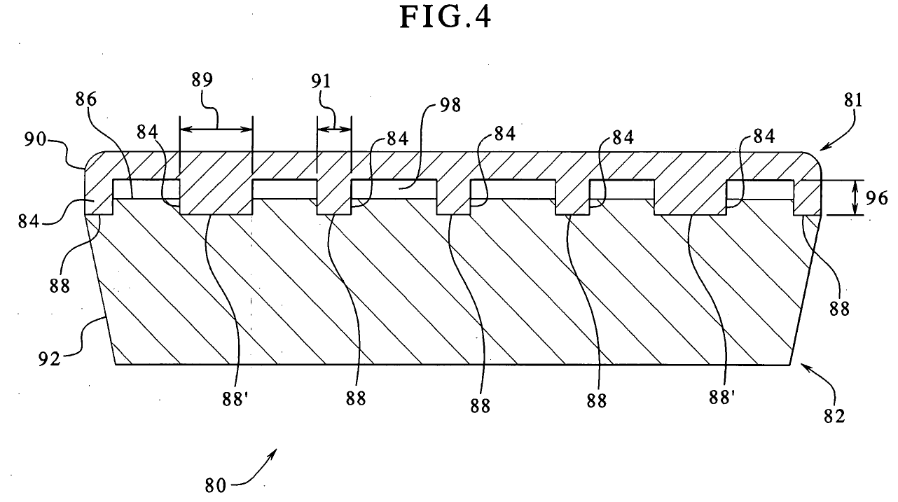

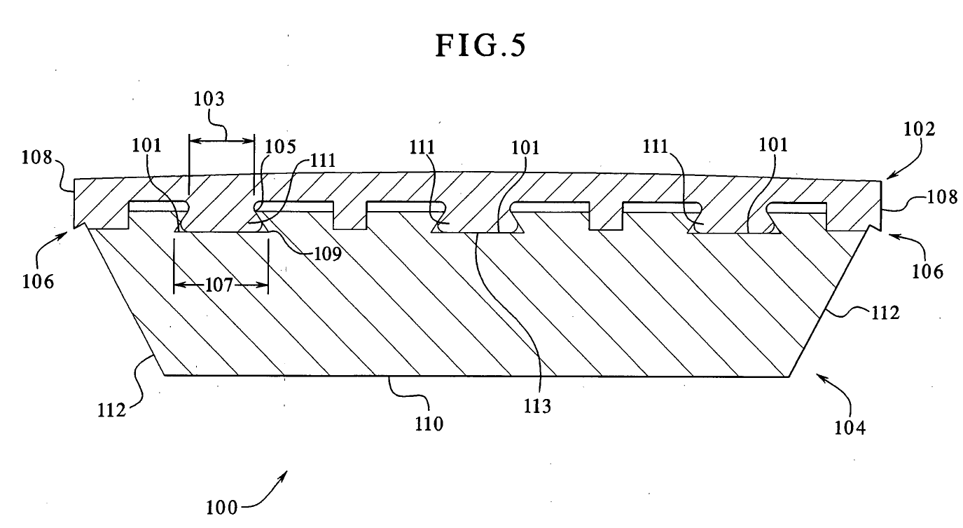

The board 4 may have a top surface 22 having a width 23 and a bottom surface 24 having a width 25. The board 6 may have a top surface 26 having a width 27 and a bottom surface 28 having a width 29. The widths 23, 25, 27, 29, in various embodiments, are in a range from 2 inches to 8 inches. In an embodiment, the width 23 of the top surface 22 is equal to the width 25 for the bottom surface 24. Similarly, the width 27 of the top surface 26 is equal to the width 29 of the bottom surface 28. It is appreciated, however, that any width may be prescribed for the top surfaces 22, 26 and/or the bottom surfaces 24, 28 wherein the top surfaces 22, 26 and the bottom surfaces 24, 28 are equal or unequal in width. For example, in an embodiment, the top surfaces 22, 26 have a greater width 23, 27 than the bottom surfaces 24, 28 thereby providing a trapezoidal shape, as illustrated in FIGS. 4 and 5 and described in further detail below. It is further appreciated that additional boards may be adjacent to the boards 4, 6 based on a desired size for the deck. These additional boards may or may not have dimensions similar to the boards 4, 6.

The deck 2 is susceptible to effects of sun-related damage, such as heat, ultraviolet rays, or moisture. While these elements may not affect an interior area 18, 20 of each board 4, 6, the top surfaces 22, 26 may become damaged and may provide an unaesthetic appearance to the deck 2. Accordingly, in an embodiment of the present invention, the boards 4, 6 are trimmed at the edges 8, 10, 12, 14 adjacent to the top surfaces 22, 26 of each board 4, 6, respectively to enable placement of covers 54, 54′ on the boards 4, 6. The trimming may be conducted using, for example, one or more tools 200, 300 described in further detail below. The trimming, in essence, leaves grooves in areas where the edges 8, 10 meet the top surface 22 and where the edges 12, 14 meet the top surface 26 along a length (not shown) of each board 4, 6.

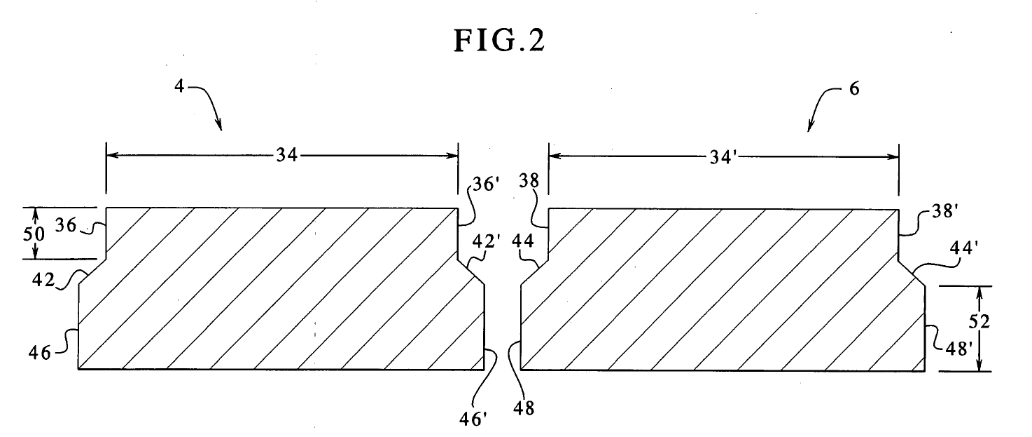

As illustrated in FIG. 2, the trimmed edges 8, 10, 12, 14 of the boards 4, 6 have a new width 34, 34′ between sections 36, 36′ and sections 38, 38′. The width 34, 34′ is less than the width 32 and provides a new distance 40 between edges 10, 12. The edges 8, 10, 12, 14 may be beveled along sections 42, 42′, 44, 44′ wherein the width of the boards 4, 6 increases to the width 32 along sections 46, 46′, 48, 48′. In an embodiment, sections 36, 36′, 38, 38′ have a height 50 which is less than a height 52 for sections 46, 46′, 48, 48′. However, it is contemplated that in other embodiments the heights 50, 52 may be equal or may be unequal. It is further contemplated that, in some embodiments, the height 50 is greater than the height 52.

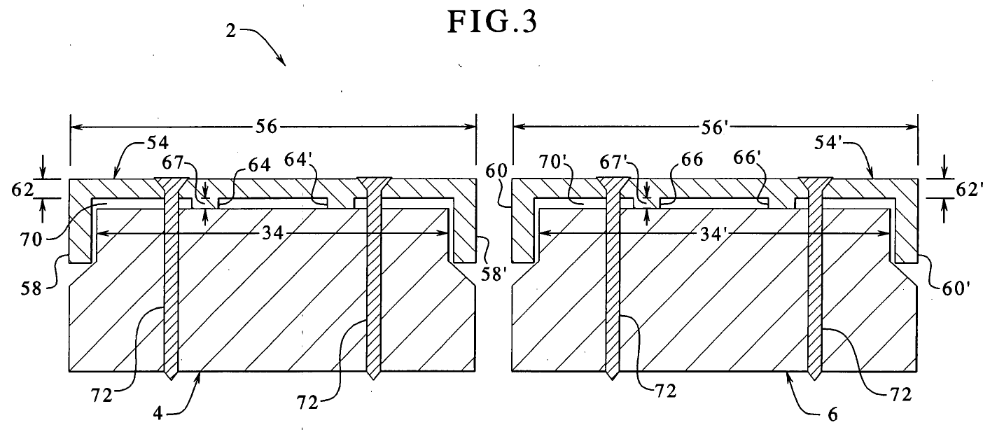

FIG. 3 illustrates the isolated portion of the deck 2 wherein the covers 54, 54′ are provided on the top surfaces 22, 26, respectively. The covers 54, 54′ may be constructed from a wood/plastic composite in a 1:1 ratio. The covers 54, 54′ have a width 56, 56′, respectively, which is greater than the width 34, 34′. Ends 58, 58′ of the cover 54 extend adjacent to sections 36, 36′. Ends 60, 60′ of the cover 54′ extend adjacent to the sections 38, 38′. Each of the covers 54, 54′ have a thickness 62, 62′ which, in an embodiment, is in a range of 3/16 inch to ⅜ inch. Stems 64, 64′ extend from the cover 54 and stems 66, 66′ extend from the cover 54′. The stems 64, 64′ and the stems 66, 66′ have a height 67, 67′, respectively, in a range from 3/32 inch to 9/16 inch. The stems 64, 64′, 66, 66′ provide a spacing 70, 70′ between the covers 54, 54′ and the top surfaces 22, 26, respectively. In an embodiment, the spacing 70, 70′ ranges from 3/32 inch to 9/16 inch. The spacing 70, 70′ may enable the boards 4, 6 to expel moisture in the form of a vapor. Many known deck covers are applied directly onto a surface of a deck and provide no spacing between the cover and the surface. Because wood expels moisture in an upward direction, pressure accumulates between the known covers and the deck surface. Eventually, the covers are displaced/delaminated from the deck surface and/or the deck surface becomes warped. By providing a space 70, 70′, the present invention allows the deck surface to expel moisture and prevents displacement/delamination.

The covers 54, 54′ may be fastened to the boards 4, 6 via an epoxy or phenolic adhesive (not shown). A fastener may be provided to secure the boards 4, 6 to, for example, a joist (not shown). In the embodiment illustrated in FIG. 3, the fastener is one or more galvanized screws 72. The screws 72 may be inserted through the covers 54, 54′ adjacent to the stems 64, 64′, 66, 66′ and may penetrate through the interior area 18, 20 of the board 4, 6, respectively. The covers 54, 54′ prevent direct contact of the boards 4, 6 by elements, such as solar radiation or moisture. As a result, the top surfaces 22, 26 may maintain an aesthetic appearance and the deck may be used for a prolonged period of time.

FIG. 4 illustrates a board assembly 80 in another embodiment of the present invention. The board assembly 80 has a cover 81 which is attached to a board 82. A width 87 of the board adjacent to a top surface 86 is greater than a width 89 adjacent to a bottom surface 91. In an embodiment, a difference between the width 87 and the width 89 is 1 inch. Accordingly, implementation of two or more boards 82 to form, for example, a deck floor, may allow adequate spacing to prevent contaminants and other debris from being trapped between boards 82. Stems 84, 84′ of the cover 81 are attached to the top surface 86 of the board 82 via an epoxy or phenolic resin adhesive (not shown) in, for example, a lamination process. Additional types of adhesives capable of forming a wood and wood/plastic composite bond are also contemplated. Recessions 88, 88′ are formed within the top surface 86 to receive the stems 84, 84′. Ends 90 of the cover 81 extend to edges 92 of the board 82. The cover 81 may form an apex 93 or crown which enables liquids on the cover 81 to disperse in a downward direction toward the edges 92. The edges 92 may be beveled to enable liquids in contact with the edges 92 to stream downward toward a bottom surface 94. The liquids may then completely disperse from the board 82. The stems 84, 84′ may have a height 96 which may provide a space 98 between the cover 81 and the board 82. The space 98 enables the board 82 to expel vapor from the top surface 86. Stems 84′ have a greater width 89 than a width 91 of stems 84 to enable placement of fasteners (not shown) into the stems 84′.

FIG. 5 illustrates a board assembly 100 having a cover 102 displaced on a board 104. The cover 102 has an apex 106 formed at each end 108 which points toward a bottom surface 110 of the board 104. Water or other liquids may accumulate and fall from the apex 106 to prevent the liquids from contacting edges 112 of the board 104. Accordingly, the apex 106 may reduce a rate of deterioration for the edges 112 due to moisture.

The board 104 may have recessions 101 wherein a width 103 at a top end 105 may be less than a width 107 at a bottom end 109. Stems 111 may be shaped to correspond to the recessions 101. The stems 111 may interlock with the recessions 101 in a manner similar to conventional male-female interlocking mechanisms wherein the stems 111 serve as the male member and the recessions 101 serve as the female members. In an embodiment, the stems 111 are inserted within the recessions 101 wherein the cover 102 is pressed toward the board 104 to snap the stems 111 into the recessions 101. In another embodiment, the cover 102 is aligned wherein the stems 111 may be inserted into the recessions 101 in a sliding motion. In this embodiment, the stems 111 slide along a bottom surface 113 of each of the recessions 101 across a length (not shown) of the board 104.

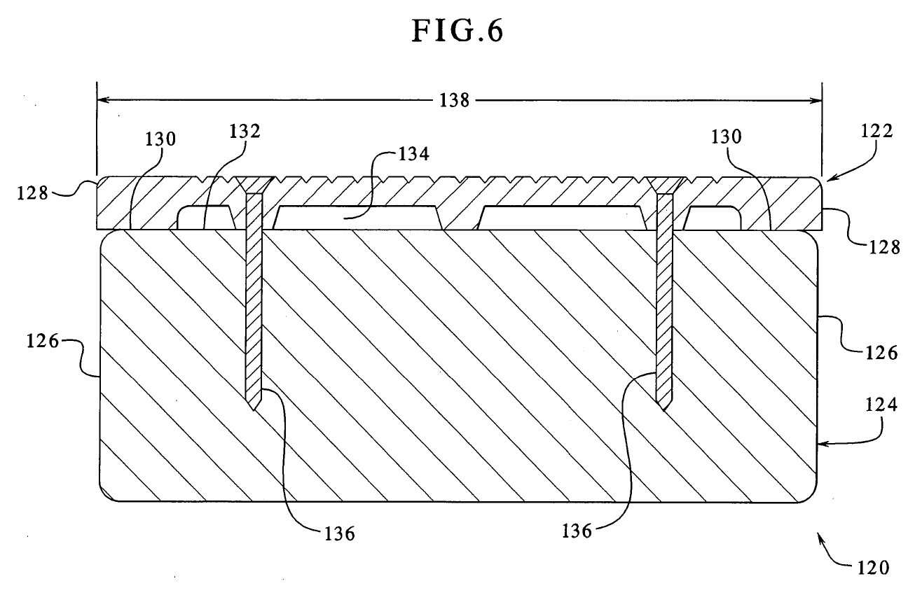

FIG. 6 illustrates a board assembly 120 in which a cover 122 is placed on a board 124 which does not require trimming of edges 126 prior to attachment of the cover 122. Ends 128 of the cover 122 have a bottom surface 130 which contacts a top surface 132 of the board 124. The cover 122 may be attached to the board 124 via an epoxy or phenolic resin adhesive. Stems 132 create a space 134 between the cover 122 and board 124 which is sufficient for vapor expulsion. Fasteners, such as screws 136, may extend through the stems 132 to connect the cover 122 and the board 124 to a joist (not shown). The cover 122 has a width 138 which is sufficient to prevent direct contact between elements and the top surface 132 of the board 124.

A deck featuring board assemblies as described above may be provided to individuals in at least two different scenarios. In a first scenario, a previously constructed deck may be renovated wherein one or more boards of the deck are trimmed. Covers may then be provided for each of the boards. In a second scenario, a cover is attached to a board prior to assembly of a deck. An individual may, for example, obtain several boards having covers and assemble a deck using the prefabricated board assemblies. The prefabricated board assemblies could also be placed adjacent to boards of a pre-existing deck which an individual wishes to expand. Either scenario reduces time and effort associated with repair or replacement of a deck according to known methods. Moreover, either scenario offers a cost-effective solution to repair or replacement of a deck.

FIGS. 1-6 illustrate covers which are aligned in a parallel arrangement to boards, i.e., the length of the cover is aligned with the length of the board. However, it is contemplated that one or more covers may be attached to boards of a deck in a non-parallel arrangement, such as, for example, a 45-degree or 90-degree arrangement with respect to the lengths of the boards and covers. Non-parallel arrangements may provide an individual with an option for additional aesthetic configurations for the board assemblies. In such an embodiment, the cover may be placed directly on the deck surface without trimming of the deck, as non-parallel trimming may reduce strength of the board.

The present invention allows the use of wood composites as a construction material for the boards. Use of wood composites is favorable due to the stiffness, high modulus of elasticity, and low cost of manufacture associated with wood composites. However, wood composites were previously considered materials which could only be used indoors because they are treated with preservatives which dissipate and/or deplete due to a scouring action on the surface of the wood composite when exposed to outdoor elements. For example, zinc borate is a preservative commonly used for engineered strand lumber and borate-treated oriented strand board. Zinc borate leeches or dissipates if contacted by precipitation. However, the cover of the present invention may prevent contact between precipitation and zinc borate and thereby reduces a rate of dissipation and/or leeching for the preservative.

Typically, wooden decks are provided with joists which are spaced at intervals of 24 inches underneath floorboards to ensure that the floorboards can bear loads. Decks which are constructed from wood/plastic composites are provided with joists which are spaced at intervals of 16 inches or less underneath floorboards. Moreover, wooden decks receiving wood/plastic boards in the replacement process may require extra joists to meet the 16 inch requirement between joists. However, due to the stiffness of wood composites, such as engineered strand lumber or oriented strand-board, supporting joists could be placed anywhere from approximately 24 inches to 32 inches apart. Use of fewer joists would result in reduced labor and lower costs to construct a deck.

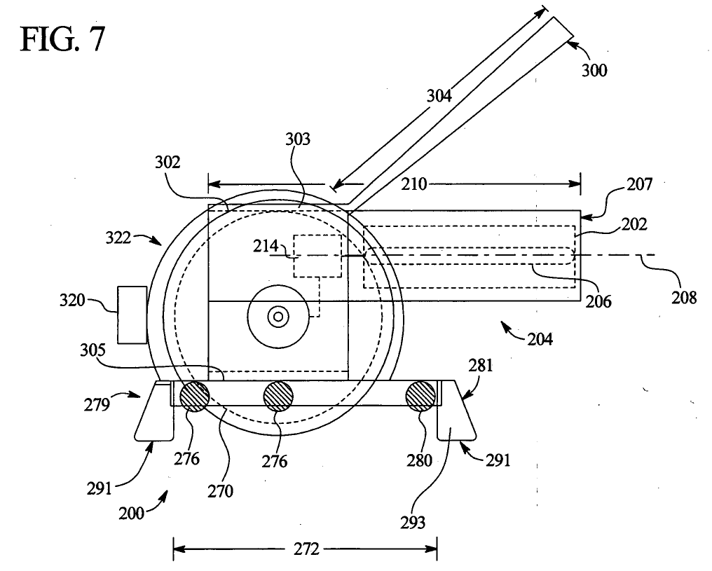

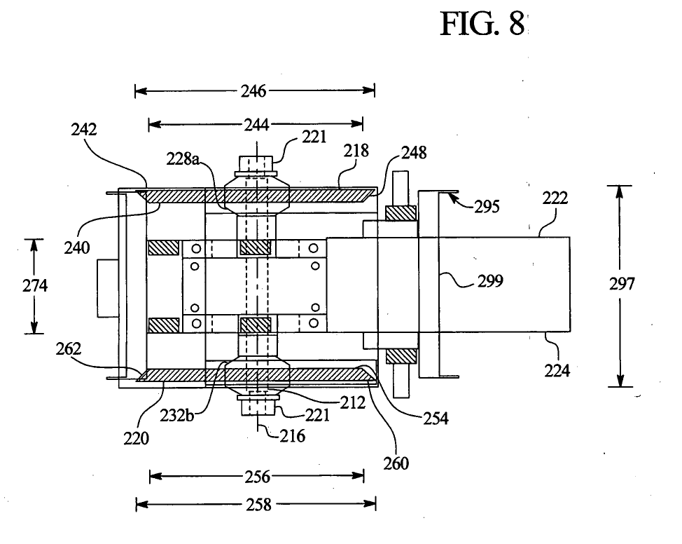

FIGS. 7, 8, 9A and 9B illustrate a tool 200 which may be used to edge profile or trim the boards 4, 6. The tool 200 has a frame 204 which encases a motor 202. In an embodiment, the frame 204 is cylindrical in shape. However, any shape is contemplated for the frame 204 which is suitable for containing the motor 202. The motor 202 has a shaft 206 which is positioned adjacent to a rear end 207 of the frame 204. The shaft 206 may be rotated in a clockwise or counterclockwise direction with respect to an axis 208 parallel to a length 210 of the frame 204. A shaft 212 is mechanically connected to the shaft 206 via a gear mechanism 214. Although the gear mechanism 214 is not illustrated in detail, it is appreciated that any type of gear mechanism which enables shafts to be mechanically connected while maintaining positions orthogonal to one another is contemplated. It is further contemplated that, in some embodiments, a series of belts may be implemented to achieve the function of the gear mechanism 214. The shaft 212 rotates in a clockwise or counterclockwise direction with respect to an axis 216 which is orthogonal to the axis 208. Rotation of the shaft 206 results in rotation of the shaft 212 via the gear mechanism 214.

Blades 218, 220 may be positioned on the shaft 212 on opposing sides 222, 224 of the frame 204. The blades 218, 220 may be constructed from, for example, steel and/or other metals. Blade 218 may be secured at a desired position onto the shaft 212 by a collar 226 having caps 228a, 228b. Blade 220 may be secured onto the shaft 212 by a collar 230 having caps 232a, 232b. Each of the caps 228a, 228b, 232a, 232b may be secured to the shaft via various mechanisms. For example, in an embodiment, the caps 228a, 228b, 232a, 232b may have threading (not shown) which may correspond to threading (not shown) along a length 234 of the shaft 212. The caps 228a, 228b, 232a, 232b may then be placed onto the shaft 212 and rotated wherein a cap traverses across the length 234 of the shaft to the desired position. In another embodiment, each of the caps 228a, 228b, 232a, 232b may have clamping mechanisms (not shown) which lock the caps 228a, 228b, 232a, 232b to a desired position on the shaft 212. In this case, a cap may be slid along the shaft 212 to a desired position and the clamping mechanism may be actuated to secure the cap to the shaft 212. The caps 228a, 228b, 232a, 232b may be trapezoidal in shape; however, any shape is contemplated which is suitable for securing the blades 218, 220 to a desired-position. Fasteners 221, such as bolts, may be adjacent to the caps 228a, 228b, 232a, 232b at ends 223 of the shaft 212.

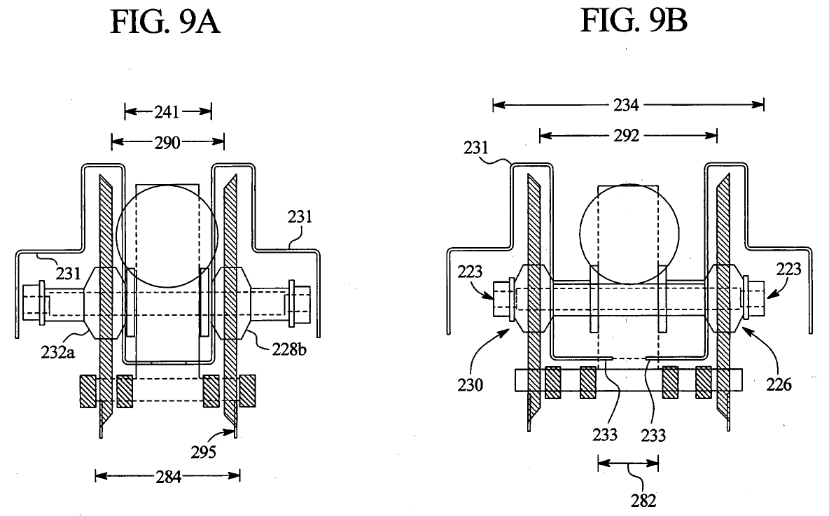

In an embodiment, illustrated in FIGS. 9A and 9B, guards 231 may be placed over the blades 218, 220 as a safety measure to prevent inadvertent contact with the blades 218, 220. The guards 231 may be constructed from wood, plastic, metal, rubber or the like. The guards 231 may have openings (not shown) which allow the guards 231 to be fitted around the shaft 212. FIGS. 9A and 9B illustrate the guards in cross-section. In these views, an entire length of the guards 231 cannot be seen. However, it is contemplated that the guards 231 extend forward and rearward to completely cover the blades 218, 220. The guards 231 may have latches 233 which extend underneath the shaft 212. The latches 233 may have openings (not shown) which may receive fasteners to secure the latches 233 to a base 270 (described in further detail below) at a desired width 241. The width 241 between the guards 231 may be adjusted as a width 290 between blades 218, 220 is adjusted.

The blade 218 has an inner surface 240 and an outer surface 242. The inner surface has a length 244 which is less than a length 246 of the outer surface 242. Accordingly, the blade 218 may have a cutting edge 248 which is slanted. Likewise, the blade 220 has an inner surface 254 having a length 256 which is less than a length 258 for an outer surface 260. The difference in length gives rise to a slanted cutting edge 262. Either of the slanted cutting edges 248, 262 may provide a beveled edge to a board similar to the sections 42, 42′, 44, 44′ illustrated in FIG. 2.

The base 270 may be attached to a bottom surface 205 of the frame 204 and may be constructed from wood, plastic, metal, or the like. The base 270 may have a length 272 which may be in a range from nine inches to sixteen inches. The base 270 may have a width 274 which may be in range from 2.5 inches to three inches. Wheels 276 may be disposed on the base 270 adjacent to a front end 279. Wheels 280 may be disposed at a rear end 281 of the base 270 on an axle 283. The wheels 276, 280 may be constructed from wood, plastic, rubber, metal, or the like. A width 282 between wheels 276 may be less than a width 284 between wheels 280. The greater width 284 enables the wheels 280 to, for example, rest on adjacent boards of a deck. For example, a deck may be constructed from conventional 2×4 boards. The width 282 between the wheels 276 may be 2.5 inches. The width 284 between the wheels 280 may be, for example, five inches, in order to contact adjacent boards on the deck and prevent the tool 200 from tilting horizontally while trimming edges. A width of five inches may also be used for boards having a 2×6 dimension to provide stability while trimming edges. Moreover, the wheels 280 may be shifted along the axle 283 to adjust the width 284 to accommodate narrower or wider boards. Still further, the tool 200 is provided with two sets of wheels 276 adjacent to the front end 279. The two sets of wheels 276 allow the tool 200 to maintain stability when, for example, a first set of wheels 276 closest to the front end 279 is moved beyond an end of a board during the trimming process.

Guides 291 may be provided at the front end 279 and the rear end 281 of the base 270. The guides 291 may be constructed from wood, plastic, metal, or the like and may have a length 297 in a range from 3.25 inches to 5.75 inches. Adhesives, fasteners or any other suitable method is contemplated for attachment of the guides 291 to the front end 279 and the rear end 281 of the base 270. The guides 291 may have tabs 293 which extend downward to contact sides of a board. Flat inner surfaces 295 enable the tabs 293 to traverse across sides of the board evenly and allow the tool 200 to maintain a consistent position during trimming. In an embodiment, the tabs 293 are adjustable in width between them and may be moved together or apart to accommodate a width of a board. Moreover, the tabs 293 may be adjusted vertically to provide an adequate contact surface with the board. It is contemplated that any type of mechanism which allows the tabs 293 to be adjusted vertically, or with respect to width, may be implemented. These mechanisms may function via sliding of the tabs 293 along a rail 299 to a desired position and/or securing the tabs in the desired position via fasteners. In an embodiment, the rail 299 may be protractable or retractable in length to accommodate a width of a board.

FIGS. 9A and 9B illustrate the tool 200 wherein the blades 218, 220 are separated at different widths to accommodate different sized boards. For example, in FIG. 9A, the blades 218, 220 may be separated by the width 290 which may accommodate a conventional 2×4 board. In FIG. 9B, the blades 218, 220 may be separated by a width 292 which may accommodate a conventional 2×6 board. As referred to earlier, the caps 228a, 228b, 232a, 232b may be moved along the shaft 212 to the desired position for separation of the blades 218, 220. The wheels 276, 280, however, may maintain their respective widths. More specifically, the width 282 may remain 2.5 inches in FIGS. 9A and 9B and the width 284 may remain 5 inches. These widths 282, 284 may be adequate for providing stability while trimming both boards.

A handle 300 may be attached to a top surface 302 of the frame 204. The handle 300 may be constructed from wood, plastic, metal, rubber, or the like. A base 303 of the handle 300 may be attached to the top surface 302 via adhesives, fasteners, or the like. The handle 300 may extend from the top surface 302 at, for example, a 45-degree angle. However, any angle is contemplated which allows an individual to grasp the handle 300 and maintain control of the tool 200 before, after and during operation of the tool 200. The handle 300 has a length 304 which is in a range from 2 feet to 7 feet. A switch (not shown) may be provided to activate the motor 202 and/or vary a speed of the motor 202.

It is contemplated that, during the trimming process sawdust or debris may collect in an area between the guards 231. Accordingly, a port 320 may be provided at a front end 322 of the tool 200. The port 320 may collect the sawdust or debris. In addition, the port 320 may provide for attachment of a vacuum tube (not shown) or other suction device. The sawdust or other debris may be delivered through the port 320 into the suction device to prevent accumulation and possible stoppage of the motor 202.

To use the tool 200, an individual may first adjust the width 290 between the blades 218, 220 to accommodate a board. More specifically, the caps 228a, 228b, 232a, 232b may be moved along the shaft 212 to the desired position for separation of the blades 218, 220. The caps 228a, 228b, 232a, 232b may then be fastened at the desired position to secure the blades 218, 220 in a desired position. The guides 291 may also be adjusted to coincide with sides of the board. The individual may then actuate the switch to begin rotation of the blades 218, 220. The tool 200 may be placed onto the board wherein the guides 291 contact the sides of the board. The individual may then grasp the handle 300 to push and/or pull the tool 200 along the top surface of the board and trim the edges adjacent to the top surface of the board. The individual may, prior to operation, attach a vacuum tube or suction device to the port 320 to remove debris collected within the guards 231.

The tool 200 of the present invention may provide numerous advantages over known tools for trimming edges of a board. For example, the tool 200 may allow an individual to maintain cut accuracy along an edge of a board independent of fluctuation in the size of the board. The fluctuation may be the result of, for example, seasonal variations in moisture content. In addition, the tool 200 may enable placement of the covers described above by providing accurate outside profile dimensions for a board. Further, the tool 200 may enable opposing edges of a board to be trimmed symmetrically independent of a gap between any boards which are adjacent to the board being trimmed. Thus, the tool 200 may be used to trim adjacent boards, as seen in a typical deck, without adjustments for gaps between the boards whether those gaps are uniformly or sporadically sized.

While the embodiments of the invention have been illustrated and described, as noted above, many changes can be made without departing from the spirit and scope of the invention. Accordingly, the scope of the invention is not limited by the disclosure of the embodiments. Instead, the invention should be determined entirely by reference to the claims that follow.

What is claimed is:

1. A tool comprising:
a frame having a length between a front end and a rear end and a width extending from a first side to a second side;
a motor associated with the frame wherein the motor has a first shaft which extends from the rear end to the front end;
a second shaft in mechanical connection with the first shaft wherein the second shaft is orthogonal-to the first shaft and wherein rotation of the first shaft causes rotation of the second shaft and further wherein the second shaft extends outward from the frame from the first side and the second side of the frame;
a first blade on the second shaft on the first side of the frame wherein the second shaft serves as an axis of rotation for the first blade and wherein a position of the first blade is adjustable along a length of the second shaft;
a second blade on the second shaft on the second side of the frame wherein the second shaft serves as an axis of rotation for the second blade and wherein a position of the second blade is adjustable along a length of the second shaft;
a base attached to a bottom surface of the frame; and
one or more wheels attached to the base.

2. The tool of claim 1 further comprising:
collars on opposing sides of the first blade wherein the collars removably secure the position of the first blade along a length of the second shaft.

3. The tool of claim 1 further comprising:
a guard covering the first blade.

4. The tool of claim 1 further comprising:
a guide attached on at least one side of the base.

5. The tool of claim 1 wherein the wheels are attached on opposing sides of the base and wherein a width between the wheels is adjustable.

6. The tool-of claim 1 wherein the first blade has an inner surface which is closest to the first side of the frame and an outer surface opposite to the inner surface and further wherein the inner surface has a shorter length than the outer surface.

7. The tool of claim 1 further comprising:
a port at the front end of the frame.

8. A tool comprising:
a frame having a length defined between a front end and a rear end and a width defined between opposing sides;
a first shaft secured within the frame wherein the first shaft extends through the frame to the opposing sides;
a first blade disposed on the first shaft on a first side of the frame wherein the first blade has an inner surface which is closest to the first side of the frame and an outer surface opposite to the inner surface and further wherein the inner surface has a shorter length than the outer surface;
a second blade disposed on the first shaft on a second side of the frame wherein the second side is opposite to the first side wherein the second blade has an inner surface being closest to the second side and an outer surface opposite to the inner surface and further wherein the inner surface has a shorter length than the outer surface;
a base connected to a bottom surface of the frame; and
guides attached on the first side and the second side of the base.

9. The tool of claim 8 further comprising:
a fastener removably securing the first blade to the first shaft wherein a position of the first blade along the first shaft is adjustable.

10. The tool of claim 8 further comprising:
a second shaft in mechanical connection with the first shaft wherein the second shaft is orthogonal to the first shaft and wherein rotation of the second shaft causes rotation of the first blade.

11. The tool of claim 8 further comprising:
a first set of wheels disposed at the front end of the frame and a second set of wheels disposed at the rear end of the frame wherein a width between the first set of wheels is less than a width between the second set of wheels.

12. The tool of claim 8 wherein a width between the guides is adjustable.

13. The tool of claim 8 further comprising:
a port attached at the front end of the frame.

14. The tool of claim 8 further comprising:
a guard covering the first blade.
